(19) United States
(12) Patent Application Publication
(10) Pub. No.: US 2013/0222416 A1
(43) Pub. Date: Aug. 29, 2013

(54) APPARATUS AND METHOD FOR PROVIDING A USER INTERFACE USING FLEXIBLE DISPLAY

(71) Applicant: Pantech Co., Ltd., (US)

(72) Inventors: Jin Wook KIM, Seoul (KR); Hui Sung Park, Seoul (KR)

(73) Assignee: Pantech Co., Ltd., Seoul (KR)

(21) Appl. No.: 13/731,585

(22) Filed: Dec. 31, 2012

(30) Foreign Application Priority Data
Feb. 29, 2012 (KR) 10-2012-0020994
Feb. 29, 2012 (KR) 10-2012-0020995

(51) Int. Cl. G09G 5/00; G06F 3/041

(52) U.S. Cl. CPC G09G 5/00; G06F 3/041
USPC 345/619; 345/173

(57) ABSTRACT

A method for controlling a terminal with a processor includes detecting a first bend on a flexible display unit; determining, using the processor, whether the first bend comprises a curvature greater than or equal to a first curvature; and displaying a plurality of virtual layers in a hierarchical order according to the first bend. A terminal includes a flexible display unit to display an image provided on a virtual layer corresponding to a reference hierarchy; a bending determination unit to determine whether a first bend of the flexible display unit includes a curvature greater or equal to a first curvature; and an interface unit to display a plurality of virtual layers in a hierarchical order according to the first bend.

### CROSS-REFERENCE TO RELATED APPLICATIONS

This application claims priority from and the benefit of Korean Patent Application No. 10-2012-0020994, filed on Feb. 29, 2012, and Korean Patent Application No. 10-2012-0020995, filed on Feb. 29, 2012, the entire disclosures of which are hereby incorporated herein by reference for all purposes.

### BACKGROUND

1. Field

The following description relates to a user interface apparatus and a method for controlling a plurality of virtual layers to be outputted based on a bend of a flexible display.

2. Discussion of the Background

A variety of operations, such as a camera, the Internet, and the like have been installed in a portable terminal. Accordingly, a number of menus, which may allow a selection of at least one of the operations of the portable terminal, have increased and complexities of these menus have increased. In addition, various types and quantities of content files, such as a picture, a music file, a digital book, and the like, that may be saved in a portable terminal have been increasing.

Accordingly, an interface to control many of these operations and providing various types of contents has become more complex. In order to access and use these operations and types of contents stored in the portable terminal, users may need to learn how to use new operations and a more complex interface.

To alleviate some of the difficulties associated with the above issues of learning how to use a complex interface, it may be important to design and generate a more intuitive interface. An intuitive interface may be designed and/or generated based on a user's experiences in the real world and thus, which may require no separate need to teach the user.

As the society advances to become a more information-oriented society, demand for display devices to process and display large information has increased. To meet such needs, various types of display devices have been developed.

Examples of display devices may include a liquid crystal display (LCD) device, a plasma display panel (PDP) device, a field emission display (FED) device, an electroluminescence display (ELD) device, and the like. The above display devices may provide excellent performance in aspects of thinness, lightness, and low power consumption. However, the above display devices use a glass substrate to endure high amounts of heat that may be generated during a manufacturing process. The use of glass substrates may provide some constraints with respect to aspects of lightness, thinness, and flexibility of the respective display devices. Accordingly, instead of using a conventional inflexible glass substrate, a more flexible material, such as plastic and the like may be used. A flexible display device that is manufactured using the flexible material capable of maintaining the display performance even though the flexible display device may be bent has emerged as a next generation of a planar display device. Even though the flexible display device may be folded or rolled like paper, the flexible display device may not be damaged and thus, may be carried while being folded or rolled.

### SUMMARY

Exemplary embodiments of the present invention provide a user interface apparatus and a method for controlling a plurality of virtual layers to be outputted based on a bend on a flexible display.

Additional features of the invention will be set forth in the description which follows, and in part will be apparent from the description, or may be learned by practice of the invention.

Exemplary embodiments of the present invention provide a method for controlling a terminal with a processor including detecting a first bend on a flexible display unit; determining, using the processor, whether the first bend comprises a curvature greater than or equal to a first curvature; and displaying a plurality of virtual layers in a hierarchical order according to the first bend.

Exemplary embodiments of the present invention provide a terminal including a flexible display unit to display an image provided on a virtual layer corresponding to a reference hierarchy; a bending determination unit to determine whether a first bend of the flexible display unit includes a curvature greater or equal to a first curvature; and an interface unit to display a plurality of virtual layers in a hierarchical order according to the first bend.

Exemplary embodiments of the present invention provide a method for controlling a display of a terminal with a processor including detecting a bend of a flexible display unit on which a plurality of virtual layers is displayed; determining, using the processor, whether the bend includes a curvature greater than or equal to a first curvature; setting a hierarchical display area on the flexible display unit and displaying a plurality of indicators corresponding to the virtual layers in the hierarchical display area in response to the detected bend; and displaying the virtual layer corresponding to the bend in the hierarchical a display area of the flexible display unit.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a configuration of a portable terminal having a flexible display unit according to an exemplary embodiment of the present invention.

FIG. 2 illustrates types of information determined when a flexible display unit is bent according to an exemplary embodiment of the present invention.

FIG. 3A illustrates a flexible display unit with at least a first curvature according to an exemplary embodiment of the present invention.

FIG. 3B illustrates a flexible display unit with at least a second curvature according to an exemplary embodiment of the present invention.

FIG. 4 illustrates a flexible display unit with at least a third curvature according to an exemplary embodiment of the present invention.

FIG. 5A and FIG. 5B illustrate a different layer selected based on a bent shape of a flexible display unit according to an exemplary embodiment of the present invention.

FIG. 6 illustrates a position of a hierarchical display area in a flexible display unit according to an exemplary embodiment of the present invention.

FIG. 7 illustrates a position of a hierarchical display area in a flexible display unit according to an exemplary embodiment of the present invention.

FIG. 8A illustrates a flexible display unit with at least a first curvature according to an exemplary embodiment of the present invention.

FIG. 8B illustrates a flexible display unit with at least a second curvature according to an exemplary embodiment of the present invention.

FIG. 9 illustrates an operation of selecting a layer of a different hierarchy using a curvature and a touch of a flexible display unit according to an exemplary embodiment of the present invention.

FIG. 10 is a flowchart illustrating a method for hierarchically displaying and controlling layers using a curvature of a flexible display unit according to an exemplary embodiment of the present invention.

FIG. 11 illustrates a portable terminal having a flexible display unit according to an exemplary embodiment of the present invention.

FIG. 12 illustrates a portable terminal having a flexible display unit according to an exemplary embodiment of the present invention.

FIG. 13A and FIG. 13B illustrate a portable terminal including a flexible display unit according to an exemplary embodiment of the present invention.

FIG. 14 illustrates a portable terminal including a flexible display unit according an exemplary embodiment of the present invention.

FIG. 15 illustrates a piezoelectric film sensor disposed to sense bending of a flexible display unit according to an exemplary embodiment of the present invention.

FIG. 16 illustrates a reference line to set a position of a hierarchical display area in a user interface apparatus according to an exemplary embodiment of the present invention.

FIG. 17 illustrates selecting a layer in a user interface apparatus according to an exemplary embodiment of the present invention.

FIG. 18A and FIG. 18B illustrate a bending direction of a flexible display unit according to an exemplary embodiment of the present invention.

FIG. 19 is a flowchart illustrating a method for hierarchically displaying and controlling layers in a user interface apparatus according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that when an element is referred to as being “connected to” another element, it can be directly connected to the other element, or intervening elements may be present. Further, it will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

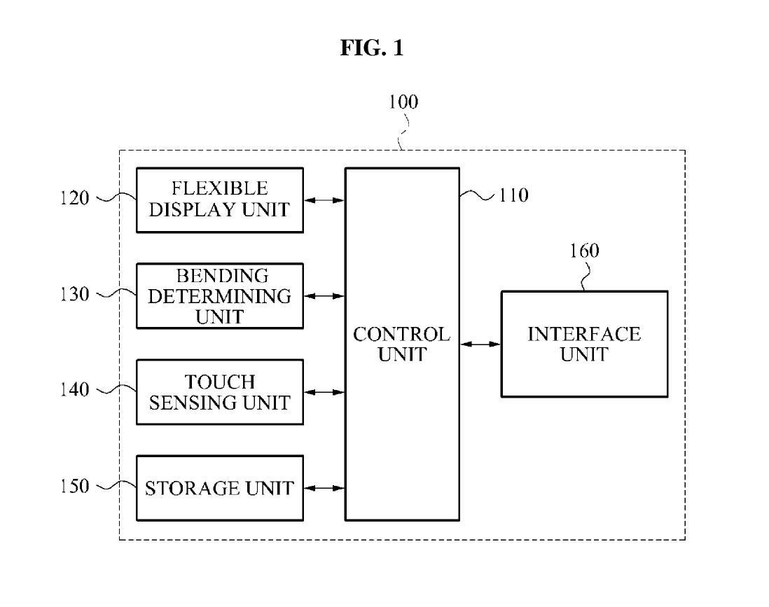

FIG. 1 is a block diagram illustrating a configuration of a portable terminal or a user interface apparatus having a flexible display unit according to an exemplary embodiment on the present invention.

Referring to FIG. 1, the portable terminal or the user interface apparatus 100 includes a control unit 110, a flexible display unit 120, a bending determining unit 130, a touch sensing unit 140, a storage unit 150, and an interface unit 160. Although the description is provided with respect to a portable terminal, aspects of the invention are not limited thereto such that the described user interface apparatus may be applied to stationary terminals as well, such as a desktop computer monitor, a television, and the like.

The flexible display unit 120 may refer to a display unit that is bendable. The flexible display unit 120 may bend in response to physical force applied from an outside, such as a touch or grasp by a user, but is not limited thereto.

When a portion of the flexible display unit 120 is sensed or detected as being bent, the bending determining unit 130 may determine information associated with the sensed bend. Information associated with the bend may include at least one of a curvature, a range, and a direction of the bend.

An operation of the bending determining unit 130 may be controlled by the interface unit 160.

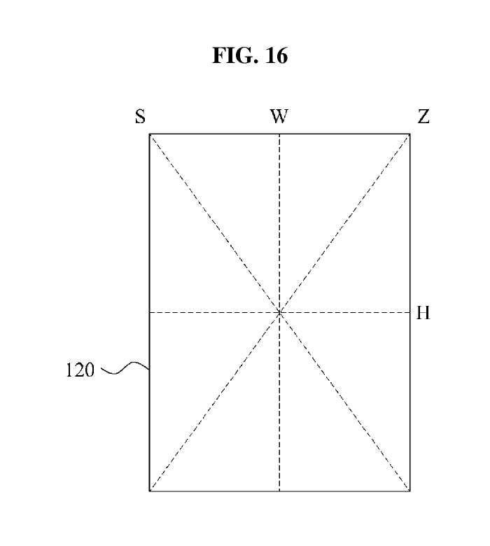

The bending determining unit 130 may sense a bend at a portion of the flexible display unit 120 using at least one piezoelectric film sensor that may electrically convert a physical touch into an electrical signal. The piezoelectric film sensor may be disposed at a rear portion or an end portion of the flexible display unit 120, and may output resistance of about 10 kilohms (Ku) in a planar state and electrical resistance of about 15 KΩ to 30 KΩ when the flexible display unit 120 is in a bending state of about 90 degrees. Accordingly, the piezoelectric film sensor may further provide a bending level of the bend sensed in the flexible display unit 120 to the bending determining unit 130. In an example, the piezoelectric film sensor may be disposed as shown in FIG. 15, but is not limited thereto. For example, the piezoelectric film sensor may be disposed at various portions of the flexible display unit 120. Further, the bending determining unit 130 may use other sensors to sense a bend on the flexible display unit 120 and is not limited to the piezoelectric film sensor.

FIG. 15 illustrates a piezoelectric film sensor disposed to sense bending of a flexible display unit according to an exemplary embodiment of the present invention.

Referring to FIG. 15, a first piezoelectric film sensor 1510, a second piezoelectric film sensor 1520, a third piezoelectric film sensor 1530, a fourth piezoelectric film sensor 1540, and a fifth piezoelectric film sensor 1550 are disposed in hatched portions.

The bending determining unit 130 may determine a bending level with respect to a bending manipulation line indicated as a dotted line, based on the sensing result of at least one of the first piezoelectric film sensor 1510, the second piezoelectric film sensor 1520, the third piezoelectric film sensor 1530, the fourth piezoelectric film sensor 1540, and the fifth piezoelectric film sensor 1550.

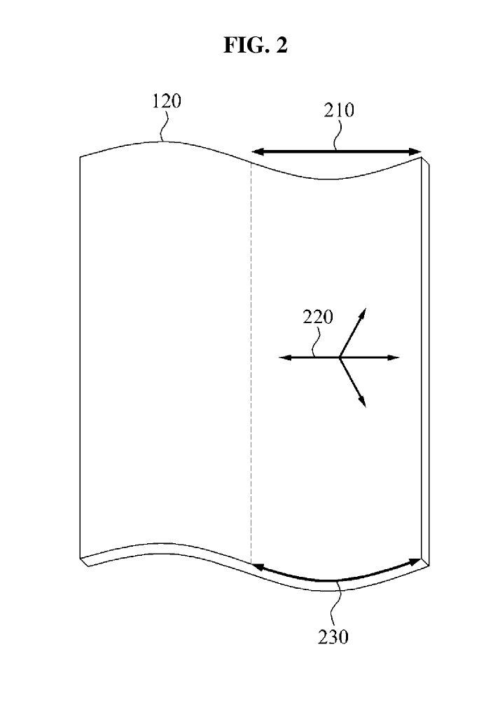

Bending information determined by the bending determining unit 130 may be provided as shown in FIG. 2.

FIG. 2 illustrates types of information determined when the flexible display unit is bent according to an exemplary embodiment of the present invention. Referring to FIG. 2, the bending determining unit 130 may determine at least one of a bending width 210, which may be transformed due, at least in part, to bending of the flexible display unit 120, a bending direction 220 of the flexible display unit 120, a bending curvature 230 of the flexible display unit 120, and the like.

The bending width 210 may refer to a distance between a first portion of the flexible display unit 120 that may not be bent, as indicated by the dotted line, to a second portion of the flexible display unit 120 that may not be bent. The respective distance or the bending width 210 includes a sensed bend. The bending direction 220 may refer to a direction in which the flexible display unit 120 may be bent. For example, the bending direction 220 may generally refer to a direction along a horizontal axis, a vertical axis, or a combination of the two axes. The bending curvature 230 may refer to a shape of the sensed bend when seen from a side view.

The bending determining unit 130 may determine a bending curvature of the flexible display unit 120 using the sensing result of at least one piezoelectric film sensor. Also, the bending determining unit 130 may sense a bent shape of the flexible display unit 120 using the sensing result, and may compute the bending width 210 and the bending direction 220 based on the bent shape.

When the flexible display unit 120 is touched or receives a touch input, the touch sensing unit 140 may sense or detect the provided touch input.

The storage unit 150 may store an operating system, which may control at least one of an overall operation of the portable terminal 100, an application program using virtual layers, and storage data.

When the flexible display unit 120 is bent by at least a reference curvature, the interface unit 160 may set, as a hierarchical display area, a portion of the flexible display unit 120. Further, the interface unit 160 may display, on the hierarchical display area of the flexible display unit 120, indicators associated with one or more virtual layers or portions of the virtual layers that may be accessed or provided through the flexible display unit 120. The indicators associated with the virtual layers may be provided in a hierarchical manner. When a touch on the hierarchical display area is sensed or received, the interface unit 160 may select a virtual layer corresponding to a portion of the hierarchical display area receiving the touch, or a touched area. The touched area may correspond to a specific virtual layer corresponding to the reference hierarchy. The interface unit may display the selected virtual layer on the flexible display unit 120.

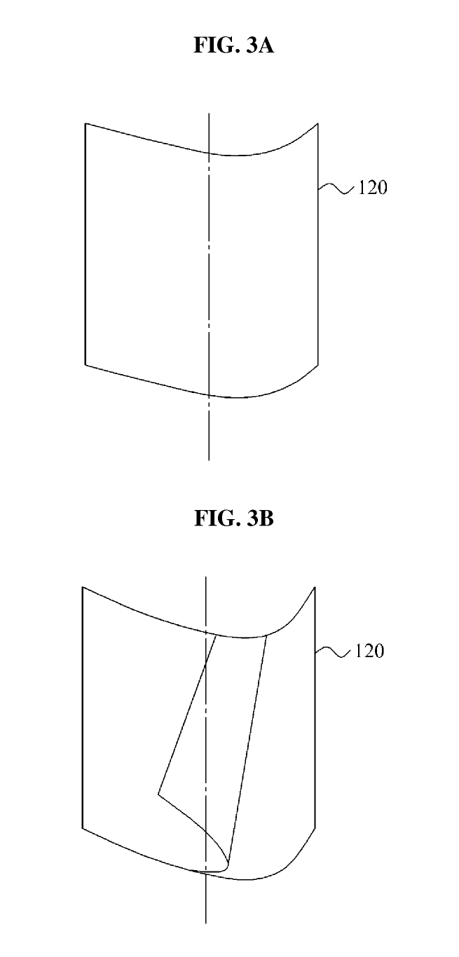

When the flexible display unit 120 is bent by at least a first curvature, the interface unit 160 may hierarchically sort one or more virtual layers that may be accessible. When the flexible display unit 120 is bent by at least a second curvature, the interface unit 160 may select a virtual layer of a subsequent hierarchy and display the selected virtual layer on the flexible display unit 120, as shown in FIG. 3. Here, the second curvature may be greater than the first curvature, but is not limited thereto.

The interface unit 160 may also control an operation of the bending determining unit 130. The interface unit 160 may control the bending determining unit 130 to operate when a reference application is driven. More specifically, the interface unit 160 may enable an interface using the flexible display unit 120 to be serviced when a reference application is driven.

FIG. 3A illustrates a flexible display unit with at least a first curvature according to an exemplary embodiment of the present invention. FIG. 3B illustrates a flexible display unit with at least a second curvature according to an exemplary embodiment of the present invention.

Referring to FIG. 3A, the flexible display unit 120 is bent by at least the first curvature. The interface unit 160 may hierarchically sort virtual layers that may be accessible.

Referring to FIG. 3B, the flexible display unit 120 is bent by at least the second curvature. In this state, the interface unit 160 may select a virtual layer of a subsequent hierarchy and display the selected virtual layer on the flexible display unit 120. In an example, one or more virtual layers may display an image on the flexible display unit 120, which may be switched or flipped between from another virtual layer or a virtual page similar to turning a page in a reading material, such as book, newspaper, or a magazine. More specifically, the flexible display unit 120 may initially display a first virtual layer, which may illustrate a first image, and when the flexible display unit 120 is bent by at least the second curvature, the first virtual layer may be replaced with a second virtual layer, which may illustrate a second image. Accordingly, by applying the effect of turning a page of a reading material, the interface unit 160 may enable the currently displayed layer to disappear.

More specifically, when a virtual layer of a different hierarchy (e.g., a second layer) is selected and the selected virtual layer may be displayed on the flexible display unit 120, the interface unit 160 may enable the selected virtual layer to be transitionally displayed over the previous virtual layer (e.g., a first layer). In an example, the second layer may be transitionally displayed over the first layer similar to turning a page of a book, sliding over the first layer, making the currently displayed layer or the first layer disappear, or the like. The interface unit 160 may adjust a transition speed to switch from the first layer to the second layer based on a bending level of the flexible display unit 120. However, aspects of the invention are not limited thereto, such that multiple virtual layers may be displayed on the flexible display unit 120.

One or more virtual layers displayed by the portable terminal 100 may correspond to, without limitation, at least one of a virtual page of an electronic book (e-book) when an e-book application is executed, a plurality of menu windows, electronic mails transmitted and received when an e-mail application is executed, and applications that are being currently executed, and other types of applications that may be hierarchically displayed.

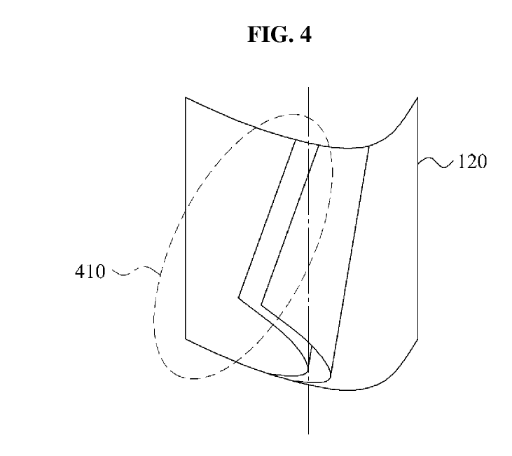

As shown in FIG. 4, when the flexible display unit 120 is bent by at least a third curvature, the interface unit 160 may determine the number of virtual layers with various hierarchies based on a bending level of the flexible display unit 120. Further, the interface unit 160 may select a hierarchy by skipping the virtual layers of hierarchies corresponding to the determined number of hierarchies, select a virtual layer corresponding to the selected hierarchy, and display the selected virtual layer on the flexible display unit 120. Here, the third curvature may be greater than the first curvature and the second curvature.

FIG. 4 illustrates a flexible display unit with at least a third curvature according to an exemplary embodiment of the present invention.

Referring to FIG. 4, the flexible display unit 120 is bent by at least the third curvature and the number of virtual layers of various hierarchies determined by the interface unit 160 based on the bending level is two. The interface unit 160 may enables a virtual layer corresponding to the third hierarchy (e.g., a third layer) to be displayed on the flexible display unit 120 by skipping virtual layers corresponding to two hierarchies (e.g., a first layer and a second layer) using a page turning effect 410.

Also, while the flexible display unit 120 may be bent by at least a fourth curvature, the interface unit 160 may sequentially select a virtual layer corresponding to a lower hierarchy (e.g., a fourth layer) and display the selected virtual layer on the flexible display unit 120. Here, the fourth curvature may be greater than the first curvature and the second curvature.

As shown in FIG. 3 and FIG. 4, for example, when exemplary embodiments of the present invention is applied to a book application, it may be possible to provide an intuitive interface that enables a displayed virtual page, which may correspond to a virtual layer of specific hierarchy, to be turned or switched to a different virtual page when the flexible display unit 120 is bent above a first reference threshold. Further, it may be possible to enable the displayed virtual pages to be turned by a plurality of virtual pages, virtual chapters, sections, or when the flexible display unit 120 is bent above a second reference threshold.

The above interface may be generated based on the user's experience in the real world and thus, the provided interface may enable the user to learn how to use an interface without extensive effort.

Further, when the flexible display unit 120 is bent by at least the first curvature, the interface unit 160 may change a method of sorting virtual layers that are outputted through the flexible display unit 120 based on a shape of the flexible display unit 120, which may be bent to be convex or concave.

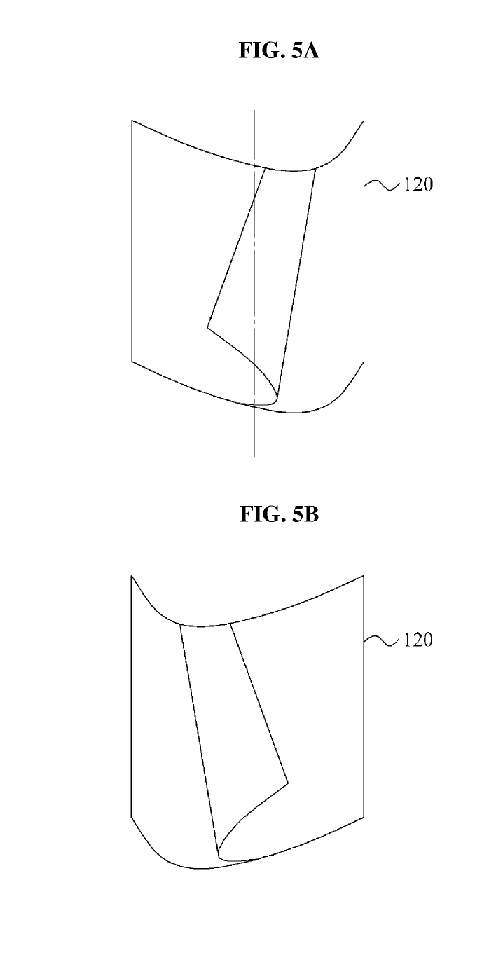

As shown in FIG. 5A, when a bend having a first curvature or a right curvature of the flexible display unit 120 based on a reference line is further bent to be at least a second curvature, the interface unit 160 may select a virtual layer of a subsequent hierarchy (e.g., a second layer) and display the selected virtual layer on the flexible display unit 120. When a bend having a third curvature or a left curvature of the flexible display unit 120 based on the reference line is further bent to be at least a fourth curvature, the interface unit 160 may select a virtual layer of a previous hierarchy (e.g., a first layer) and display the selected virtual layer on the flexible display unit 120.

FIG. 5A and FIG. 5B illustrate a different layer selected based on a bent shape of a flexible display unit according to an exemplary embodiment of the present invention.

Referring to FIG. 5A, a bend with a first curvature or a right curvature of the flexible display unit 120 may be determined to be greater than a reference threshold based on the reference line, which may be indicated as a dotted line. Since the bend with the right curvature may be bent further by at least a second curvature, a virtual layer of a subsequent hierarchy (e.g., a second layer) may be displayed with a page turning effect.

Referring to FIG. 5B, a bend with a third curvature or a left curvature of the flexible display unit 120 may be determined to be greater than a reference threshold based on the reference line, which may be indicated as a dotted line. Since the bend with the left curvature may be bent by at least a fourth curvature, a virtual layer of a previous hierarchy (e.g., a first layer) may be displayed with a page turning effect.

However, aspects of the invention are not limited thereto, such that the method for selecting, by the interface unit 160, a virtual layer corresponding to a subsequent hierarchy or a previous hierarchy based on a reference line may be applicable to other curvatures. More specifically, when the right curvature of the flexible display unit 120 based on the reference line is bent to be at least a fifth curvature, the interface unit 160 may select a virtual layer of a corresponding hierarchy (e.g., a fifth layer) by skipping, in a first direction, virtual layers of hierarchies corresponding reference curvatures and may display the selected virtual layer on the flexible display unit 120. When the left curvature of the flexible display unit 120 based on the reference line is bent to be at least a sixth curvature, the interface unit 160 may select a virtual layer of a corresponding hierarchy by skipping, in a second direction, virtual layers of hierarchies corresponding reference curvatures and may display the selected virtual layer on the flexible display unit 120.

When the flexible display unit 120 is bent by at least the first curvature, the interface unit 160 may set a portion of the flexible display unit as a hierarchical display area and display, on the hierarchical display area, virtual layers that are being output through the flexible display unit 120. The virtual layers may be displayed in a hierarchical order. The interface unit 160 may set the hierarchical display area at a reference position, or may set, as the hierarchical display area, an edge or a corner at which the flexible display unit 120 has a reference bending curvature, which may be a high bending curvature above a reference threshold, based on the reference line.

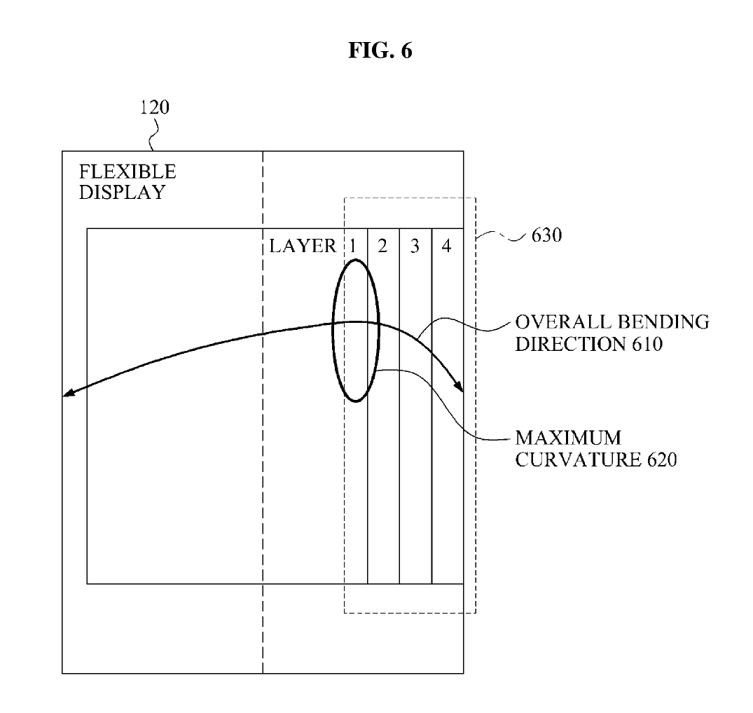

FIG. 6 illustrates a position of a hierarchical display area in a flexible display unit according to an exemplary embodiment of the present invention.

Referring to FIG. 6, a maximum curvature 620 obtained as a result of determining a bending direction 610 of the flexible display unit 120 may be distributed in a right direction based on a dotted reference line and thus, the interface unit 160 may set a hierarchical display area 630 of a reference size on a right edge portion. The hierarchical display area 630 may have a reference size, and may vary based on the number of virtual layers to be displayed on the hierarchical display area 630.

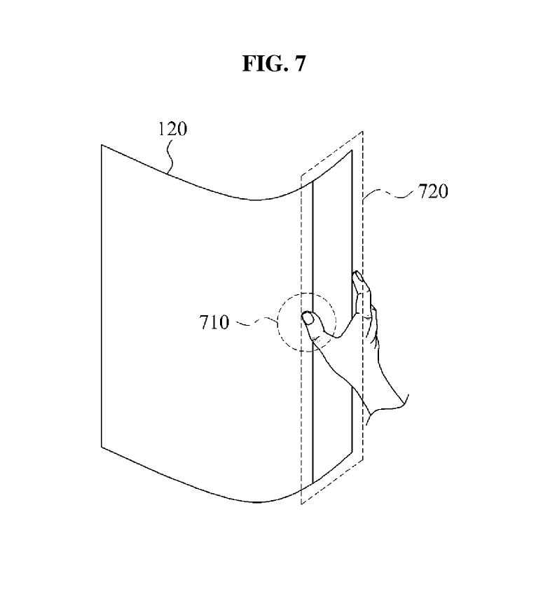

As shown in FIG. 7, when the flexible display unit 120 is sensed to be bent by at least a reference curvature in a state of being touched, the interface unit 160 may set, as a hierarchical display area, an area ranging from a touched position to a reference portion, such as an edge portion, of the flexible display unit 120.

FIG. 7 illustrates a position of a hierarchical display area in a flexible display unit according to an exemplary embodiment of the present invention.

Referring to FIG. 7, when the flexible display unit 120 is sensed to be bent by at least a reference curvature in a state of being touched, the interface unit 160 may determine a touched position 710 as a first position or a start position of a hierarchical display area 720 and set, as the hierarchical display area 720, an area ranging up to a reference portion, such as an edge portion, of the flexible display unit 120.

The edge portion may correspond to a second position or an end position of the hierarchical display area 720. Further, the edge portion may consider at least one of a bending direction, a maximum curvature of the flexible display unit 120, and may also consider an edge portion of the flexible display unit 120.

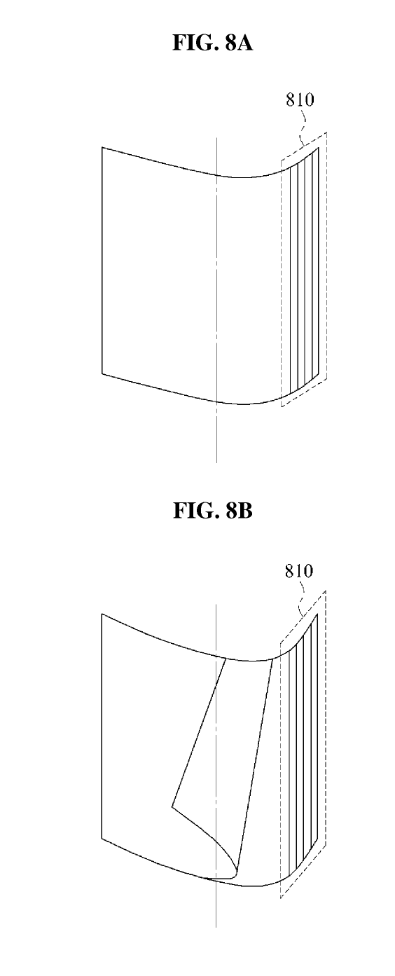

FIG. 8A illustrates a flexible display unit with at least a first curvature according to an exemplary embodiment of the present invention. FIG. 8B illustrates a flexible display unit with at least a second curvature according to an exemplary embodiment of the present invention.

Referring to FIG. 8A, the flexible display unit 120 may have a bend with at least a first curvature. The interface unit 160 may hierarchically sort and display, on a hierarchical display area 810, virtual layers that may be accessible.

Referring to FIG. 8B, the flexible display unit 120 may have a bend with at least a second curvature. Accordingly, the interface unit 160 may select corresponding to the second curvature, a virtual layer of a subsequent hierarchy (e.g., a second layer) and display the selected virtual layer on the flexible display unit 120. The interface unit 160 may not display an upper hierarchy of the selected hierarchy on the hierarchical display area 810 and may readjust a size of the hierarchical display area 810.

When the hierarchical display area is bent by at least a fifth curvature, the interface unit 160 may select a virtual layer corresponding to a position of a curvature above a reference threshold, such as a maximum curvature, within the hierarchical display area (e.g., a last layer among the accessible virtual layers) and may display the selected virtual layer on the flexible display unit 120.

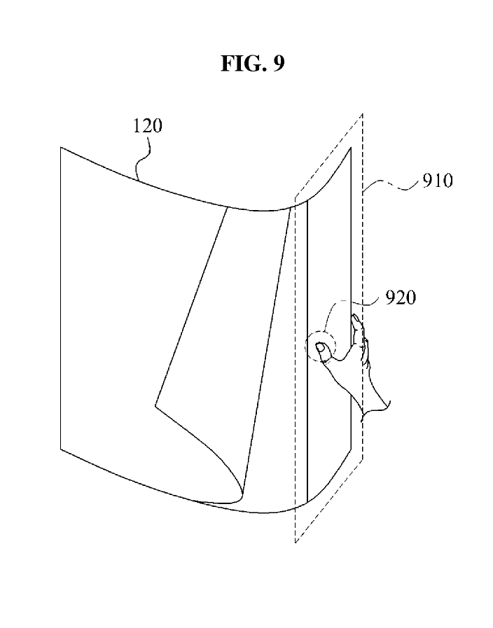

Referring to FIG. 9, to prevent or reduce a likelihood of a virtual layer from being selected due to an unintended bending operation by a user, when the hierarchical display area is touched and when the flexible display unit 120 is bent by at least the second curvature, the interface unit 160 may select a virtual layer of a corresponding hierarchy (e.g., a second layer) and display the selected virtual layer on the flexible display unit 120. The above method of selecting, by the interface unit 160, a touch on a hierarchical display area and a curvature thereof may be applicable to other curvatures.

FIG. 9 illustrates an operation of selecting a layer of a different hierarchy using a curvature and a touch of a flexible display unit according to an exemplary embodiment of the present invention.

Referring to FIG. 9, when the flexible display unit 120 is bent by at least a second curvature when a hierarchical display area 910 receives a touch input 920, the interface unit 160 may select a virtual layer of a corresponding hierarchy (e.g., a second layer) and display the selected virtual layer on the flexible display unit 120.

The interface unit 160 may determine whether bending of the flexible display unit 120 is greater than or equal to a reference curvature. Here, the reference curvature may refer to at least a first curvature, a second curvature, a third curvature, a fourth curvature, a fifth curvature, and the like.

When the interface unit 160 provides one or more operations for the respective curvatures, the relationship between the respective curvatures may be established, such that a magnitude of curvatures may be in an order of a first curvature<a second curvature<a third curvature<a fourth curvature<a fifth curvature. However, aspects of the invention are not limited thereto, such that magnitude of curvatures may be provided in a reversed order, or in a different order.

The control unit 110 may perform one or more management operations of the portable terminal 100. The control unit 110 may control an operation of the interface unit 160. The control unit 110 and the interface unit 160 are separately illustrated to more clearly describe the respective operations, but are not limited thereto. Accordingly, the control unit 110 may include at least one processor configured to perform one or more operations of the interface unit 160. Also, the control unit 110 may include at least one processor configured to perform a portion of operations of the interface unit 160.

Even though a hierarchical display area is described to be displayed on only one side of the flexible display unit 120, aspects of the invention are not limited thereto, such that a plurality of hierarchical display areas may be displayed on various portions of the flexible display unit 120. For example, in an e-book application, the interface unit 160 may display, on a first portion or a right portion of the flexible display unit 120, a hierarchical display area, which may include virtual layers sorted in an ascending order, and may display, on a second portion or a left portion of the flexible display unit 120, a hierarchical display area, which may include virtual layers sorted in a descending order. More specifically, with respect to the e-book application, the right portion of the flexible display unit 120 may display a right page, similar to a book, which may be turned to display a next subsequent page; and the left portion of the flexible display unit 120 may display a left page, similar to a book, which may be turned to display a previous page.

Hereinafter, an interface method using a bending operation of a flexible display according to exemplary embodiments of the present invention will be described with reference to the accompanying drawings.

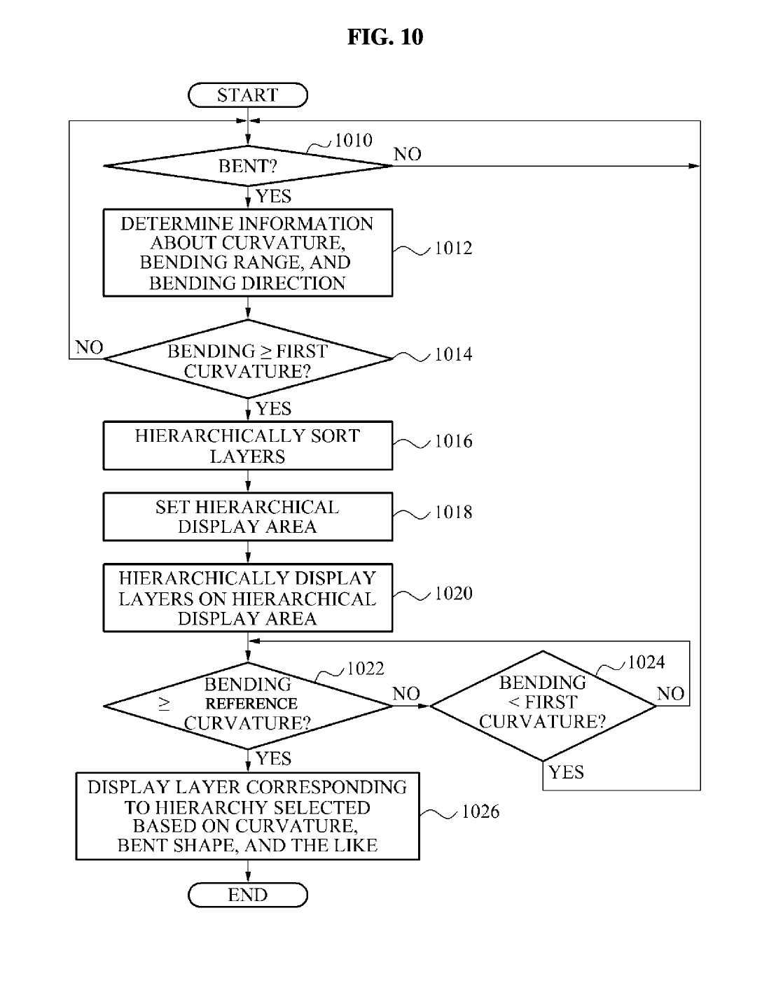

FIG. 10 is a flowchart illustrating a method for hierarchically displaying and controlling layers using a curvature of the flexible display unit according to an exemplary embodiment of the present invention.

Referring to FIG. 10, in operation 1010, a portable terminal may determine whether a flexible display unit is bent. More specifically, the portable terminal may determine whether a bend is sensed or detected on the flexible display unit.

When the flexible display unit is sensed to be bent in operation 1010, the portable terminal may determine information associated with the bend on the flexible display unit, including at least one of a curvature, a shape, a range, and a direction of the bend in operation 1012.

In operation 1014, the portable terminal may determine whether the bend of the flexible display unit is greater than or equal to a first curvature.

When the bend of the flexible display unit is determined to be less than the first curvature in operation 1014, the portable terminal may return to operation 1010.

When the bend of the flexible display unit is determined to be greater than or equal to the first curvature in operation 1014, the portable terminal may hierarchically sort virtual layers that may be present or currently executed in operation 1016. Here, the portable terminal may sort the virtual layers in a descending order or an ascending order along a direction of the bend.

In operation 1018, the portable terminal may set a portion of the flexible display unit as a hierarchical display area.

The portable terminal may set, as the hierarchical display area, a reference portion of the flexible display unit, such as an edge or a corner at which the flexible display unit has a bending curvature above a reference threshold based on a reference line. Further, when the flexible display unit is sensed to be bent by at least a reference curvature when the flexible display unit is being touched, the portable terminal may set, as the hierarchical display area, an area ranging from a touched position to the reference portion of the flexible display unit, such as an edge portion of the flexible display unit.

In operation 1020, the portable terminal may hierarchically display, on the hierarchical display area, one or more virtual layers that may be accessible or being currently executed.

In operation 1022, the portable terminal may determine whether the bend of the flexible display unit is greater than or equal to a reference curvature. The bend of the flexible display unit may be greater than multiple curvatures, including the first curvature. The bend of the flexible display unit may be adjusted such that the bend is increased or decreased to have a different curvature. The reference curvature may refer to at least one of a second curvature, a third curvature, a fourth curvature, and a fifth curvature, which may refer to a description with respect to the portable terminal 100 of FIG. 1 but are not limited thereto.

When the bend of the flexible display unit is determined to be less than the reference curvature in operation 1022, the portable terminal may determine whether the bend of the flexible display unit is adjusted or decreased to be less than the first curvature in operation 1024.

When the bend of the flexible display unit is adjusted or decreased to be less than the first curvature in operation 1024, the portable terminal may return to operation 1010. More specifically, the portable terminal may provide a screen or an image that was displayed prior to a detection of the bend in operation 1010.

When the bend of the flexible display unit is not adjusted or decreased to be less than the first curvature in operation 1024, the portable terminal may return to operation 1022.

When the bend of the flexible display unit is determined to be greater than or equal to the first curvature in operation 1022, the portable terminal may select a hierarchy based on the determined attribute of the bend, including at least one of a curvature, a shape, a range, and a direction of the bend. Further, the portable terminal may display a virtual layer corresponding to the selected hierarchy on the flexible display unit in operation 1026.

However, aspects of the invention are not limited thereto, such that multiple bends corresponding to a reference curvature may be detected by the portable terminal. More specifically, the portable terminal may perform operation 1010, operation 1012, operation 1014, operation 1016, operation 1018, and operation 1020 based on a first bend, and the portable terminal may detect a second bend to perform operation 1022 and operation 1024. For example, if the portable terminal determines that the second bend is greater than or equal to the reference curvature, the portable terminal may display a virtual layer corresponding to the selected hierarchy on the flexible display unit in operation 1026. If the portable terminal determines that the second bend is lesser than the reference curvature and also less than the first curvature, the portable terminal may revert back to a screen of the portable terminal prior to detecting the first bend.

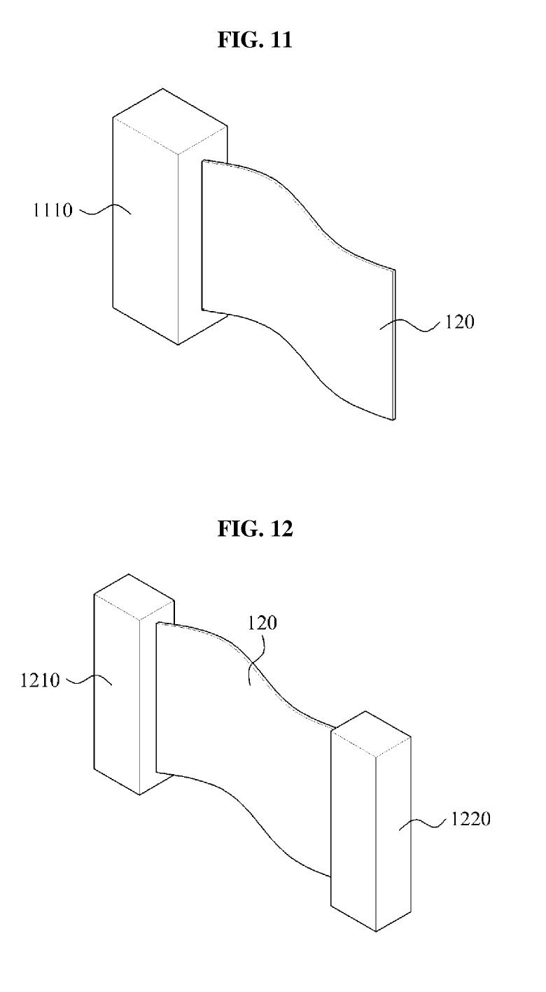

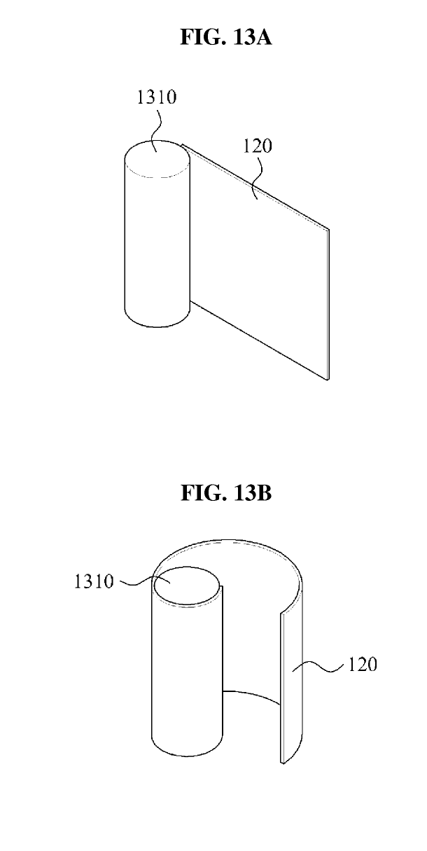

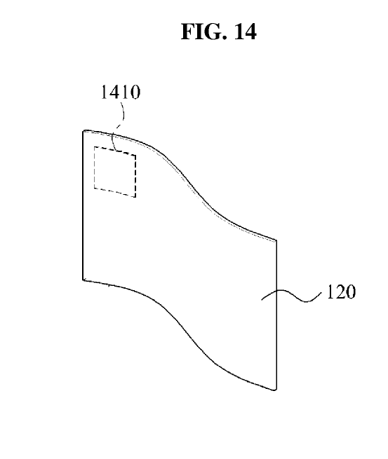

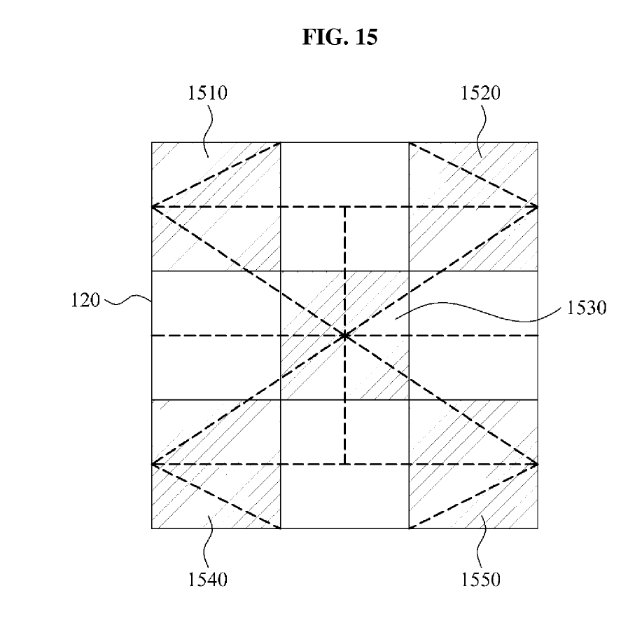

Hereinafter, a portable terminal having a flexible display according to exemplary embodiments of the present invention will be described with reference to FIG. 11, FIG. 12, FIG. 13, and FIG. 14.

FIG. 11 illustrates a portable terminal having a flexible display unit according to an exemplary embodiment of the present invention.

Referring to FIG. 11, a portable terminal may include a body 1110 on one side of the flexible display unit 120. However, aspects of the invention are not limited thereto, such that the body 1110 may be included in a portable terminal excluding the flexible display 120. Also, the body 1110 may be designed to include the flexible display unit 120 inside the body 1110.

FIG. 12 illustrates a portable terminal having a flexible display unit according to an exemplary embodiment of the present invention.

Referring to FIG. 12, a portable terminal may include a first body 1210 and a second body 1220, which may be connected on both sides of the flexible display unit 120, respectively. However, aspects of the invention are not limited thereto, such that the first body 1210 and the second body 1220 may be included in a portable terminal excluding the flexible display unit 120. Also, the first body 1210 and the second body 1220 may be designed to include the flexible display unit 120 on one side or on both sides of a portable terminal.

FIGS. 13A and FIG. 13B illustrate a portable terminal including a flexible display unit according to an exemplary embodiment of the present invention.

Referring to FIG. 13A and FIG. 13B, a portable terminal may include or be connected to a body 1310 on one side of the flexible display unit 120. However, aspects of the invention are not limited thereto, such that the body 1310 may be included in a portable terminal excluding the flexible display unit 120. Also, the body 1310 may be designed to roll the flexible display unit 120 with respect to the body 1310, and thereby include the rolled flexible display unit 120 around the body 1310.

FIG. 14 illustrates a portable terminal including a flexible display unit according to an exemplary embodiment of the present invention.

Referring to FIG. 14, a portable terminal may include a body 1410 inside the flexible display unit 120. However, aspects of the invention are not limited thereto, such that the body 1410 may be included in a portable terminal excluding the flexible display unit 120. Accordingly, the body 1410 may be flexible to bend together in response to bending of the flexible display unit 120.

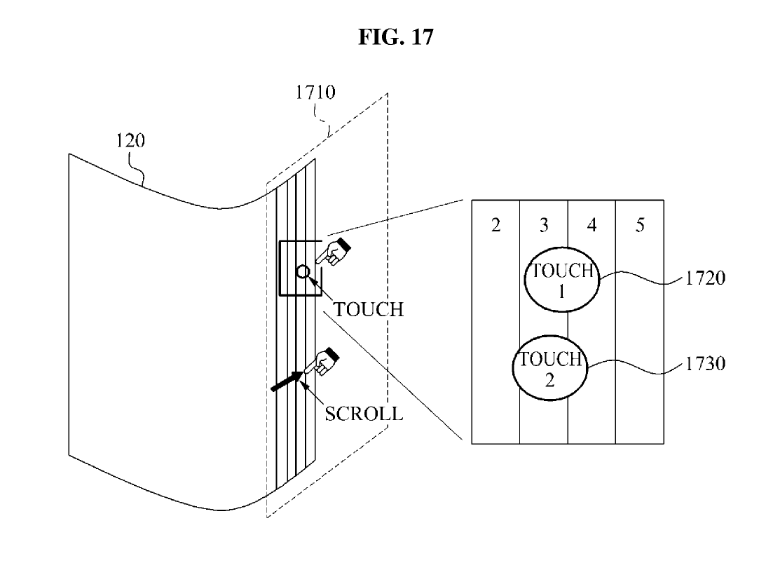

FIG. 16 illustrates a reference line to set a position of a hierarchical display area in a user interface apparatus according to an exemplary embodiment of the present invention.

Referring to FIG. 16, an interface unit, such as the interface unit 160 of FIG. 1, may determine a direction of a curvature of a bend on the flexible display unit 120 using at least four reference lines. The four reference lines may use an S axis, a W axis, a Z axis, and an H axis, but is not limited thereto. Further, the interface unit determines whether the curvature of the bend on the flexible display unit 120 is greater than a reference threshold based on the four reference lines. However, in addition to the S axis, the W axis, the Z axis, and the H axis, a reference line may be generated at any position.

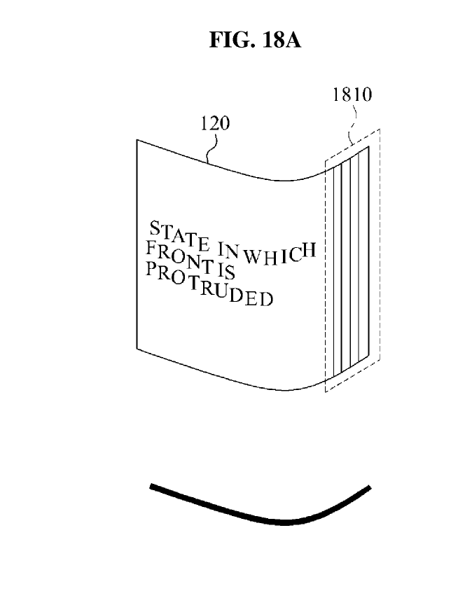

FIG. 17 illustrates selecting a layer in a user interface apparatus according to an exemplary embodiment of the present invention.

Referring to FIG. 17, when a touch is sensed on a hierarchical display area 1710, one or more virtual layers corresponding to various hierarchies, such as a first touch (1) 1720 and a second touch (2) 1730, the interface unit 160 of FIG. 1 may select a virtual layer corresponding to a higher hierarchy among the plurality of hierarchies (i.e., a fourth layer corresponding to the first touch (1) 1720). More specifically, in response to the touch (1) 1720, a third layer may be selected. In response to the touch (2) 1730, the second layer may be selected.

As shown in FIG. 17, when exemplary embodiments of the invention is applied to an application for reading a book, an interface to sense a bend and/or a touch on the flexible display unit 120 may be provided. More specifically, the interface may provide an intuitive interface that may allow a virtual page to be turned similar to turning a page of a book using a wrist and a finger when gripping and bending the book. Further, the interface may also turn a virtual page similar to turning a page of a book through sliding of a thumb when gripping and bending the book.

As described above, the intuitive interface may refer to an interface that is generated based on a user's experience in the real world and thus, may enable the user to learn how to use the interface without extensive effort.

Also, when a touch sensed on a hierarchical display area selects a plurality virtual layers corresponding to various hierarchies, the interface unit 160 may select a virtual layer corresponding to a lower hierarchy, or a virtual layer corresponding to a central region of the sensed touched.

When a touch is sensed on the hierarchical display area, the interface unit 160 may not display a virtual layer corresponding to an upper hierarchy corresponding to the touch, among the upper hierarchy and the lower hierarchy, on the hierarchical display area. For example, if touch (1) 1720 touches virtual layers corresponding to both a third hierarchy (e.g., a third layer) and a fourth hierarchy (e.g., a fourth layer), the virtual layer corresponding to the third hierarchy may be selected. However, aspects of the invention are not limited thereto, such that the virtual layer corresponding to the upper hierarchy may be selected when a touch corresponds to both a virtual layer of an upper hierarchy and a lower hierarchy. Further, the interface unit 160 may automatically select a virtual layer of a specific hierarchy based on a center point or other aspect of the touch.

Further, the interface unit 160 may readjust a size of the hierarchical display area, such that the user may select a virtual layer more accurately. More specifically, the interface unit 160 may reduce the size of the hierarchical display area with respect to a size of the virtual layer corresponding to the upper hierarchy that was selected not to be displayed, and may increase the size of remaining virtual layers included in the hierarchical display area accordingly.

When the touch on the hierarchical display area is sensed, and when a scroll operation is performed to select a lower hierarchy, among the upper hierarchy and the lower hierarchy corresponding to a touched hierarchy, the interface unit 160 may sequentially display, on the flexible display unit 120, a virtual layer corresponding to the scroll operation. Thus, the interface unit 160 may display the selected lower hierarchy according to a selection order.

When the interface unit 160 sequentially displays according to a selection order, on the flexible display unit 120, a virtual layer corresponding to the scroll operation or the virtual layer corresponding to the selected hierarchy. Accordingly, the interface unit 160 may enable the selected virtual layer to be displayed by applying the effect of turning a page of a book, the effect of sliding a currently displayed layer, or the effect of making the currently displayed layer disappear.

The interface unit 160 may adjust a speed of switching between virtual layers of various hierarchies, which may correspond to turning a page of the book in a book application, a sliding speed of the currently displayed layer, and a disappearing speed of the currently displayed layer based on a scrolling speed. For example, the interface unit 160 may enable a virtual layer to quickly disappear or switchover to another virtual layer when a quick scroll is executed, and enable a layer to slowly disappear or switchover to another virtual layer when a slow scroll is executed.

When a virtual layer corresponding to a last hierarchy is selected by the touch, the interface unit 160 may display a virtual layer corresponding to the last hierarchy and locate virtual layers corresponding to various hierarchies that may be displayed on the hierarchical display area. The other virtual layers may be displayed after or before the virtual layer corresponding to the last hierarchy to display virtual layers corresponding to the various hierarchies on the hierarchical display area.

The interface unit 160 may change a method for sorting virtual layers that may be output through the flexible display unit 120 based on a shape of the flexible display unit 120 that may be bent to be convex or concave.

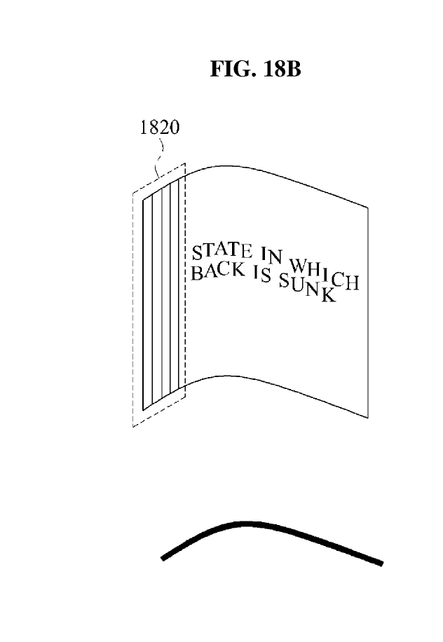

FIG. 18A and FIG. 18B illustrate a bending direction of a flexible display unit apparatus according to an exemplary embodiment of the present invention.

An upper view of FIG. 18A illustrates an example in which a front portion of the flexible display unit 120 is protruded in a direction indicated by a lower view of FIG. 18A to provide the flexible display unit 120 in a bent state in a convex form. The lower view of FIG. 18A illustrates a cross-sectional view, or a side view, of the flexible display unit 120 corresponding to the upper view.

An upper view of FIG. 18B illustrates an example in which a back portion of the flexible display unit 120 is sunk in a direction indicated by a lower view of FIG. 18B to provide the flexible display unit 120 in a bent state in a concave form. The lower view of FIG. 18B illustrates a cross-sectional view, or a side view, of the flexible display unit 120 corresponding to the upper view.

When the flexible display unit 120 is in the state of FIG. 18A, the interface unit 160 may sort virtual layers in an ascending order to display the virtual layers on a hierarchical display area 1810. When the flexible display unit 120 is in the state of FIG. 18B, the interface unit 160 may sort virtual layers in a descending order to display the virtual layers on a hierarchical display area 1820.

For example, when virtual layers corresponds to pages included in an e-book, the interface unit 160 may sort pages followed by a currently displayed page in an ascending order to display the pages on the hierarchical display area 1810. The interface unit 160 may sort pages that have been displayed before the currently display page in a descending order to display the pages on the hierarchical display area 1810.

Further, when the virtual layers being outputted through the flexible display unit 120 are displayed on the hierarchical display area, the interface unit 160 may display layer information used to identify the virtual layers. For example, when the virtual layers corresponds to pages of the e-book, the interface unit 160 may indicate a page number on a corresponding virtual layer, or may indicate a table of contents corresponding to a virtual layer.

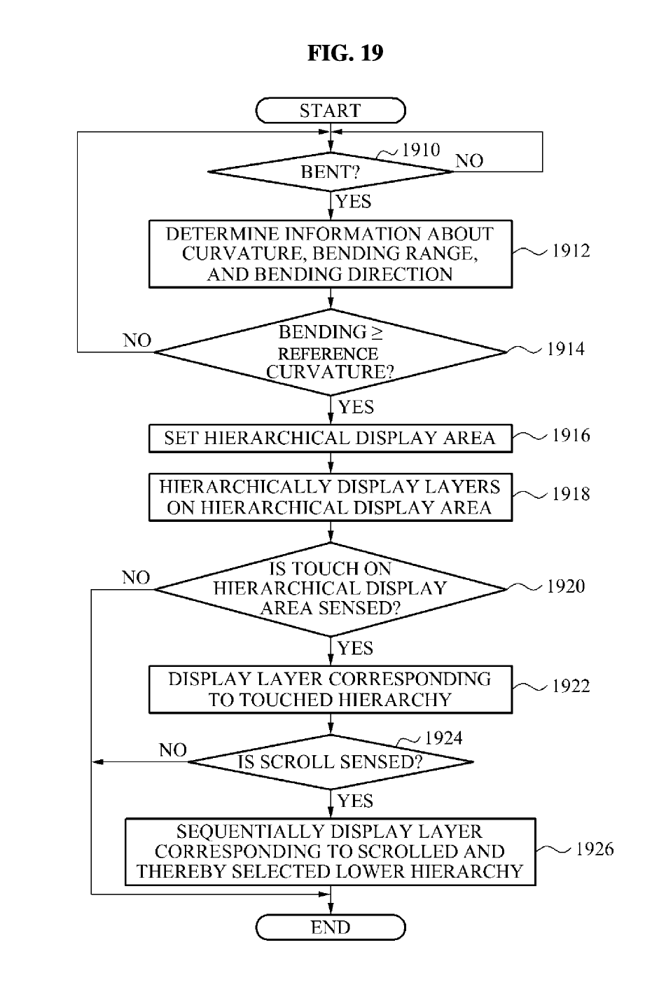

FIG. 19 is a flowchart illustrating a method for hierarchically displaying and controlling layers in a user interface apparatus according to an exemplary embodiment of the present invention.

Referring to FIG. 19, in operation 1910, a user interface apparatus determines whether the flexible display unit is bent. More specifically, the portable terminal may determine whether a bend is sensed or detected on the flexible display unit.

When the flexible display unit is sensed to be bent in operation 1910, the user interface apparatus may determine information associated with the bend on the flexible display unit, including at least one of a curvature, a shape, a, and a direction of the bend in operation 1912.

In operation 1914, the user interface apparatus may determine whether the bend of the flexible display unit is greater than or equal to a reference curvature.

When the bend of the flexible display unit is determined to be less than the reference curvature, the user interface apparatus returns to operation 1910.

When the bend of the flexible display unit is determined to be greater than or equal to the reference curvature, the user interface apparatus sets a portion of the flexible display unit as the hierarchical display area in operation 1916.

The user interface apparatus may set, as the hierarchical display area, a reference portion of the flexible display unit, such as an edge portion or a corner portion at which the flexible display unit has a bending curvature above a reference threshold based on the reference line. Further, when the flexible display unit is sensed to be bent by at least a reference curvature when the flexible display unit is being touched, the user interface apparatus 100 may set, as the hierarchical display area, an area ranging from a touched position to the reference portion of the flexible display unit, such as an edge portion of the flexible display unit.

In operation 1918, the user interface apparatus hierarchically display, on the hierarchical display area, one or more virtual layers that may be accessible or being currently output through the flexible display unit.

In operation 1920, the user interface apparatus determines whether a touch on the hierarchical display area is sensed.

When the touch on the hierarchical display is sensed in operation 1920, the user interface apparatus selects a virtual layer corresponding to a touched hierarchy and displays the selected virtual layer on the flexible display unit in operation 1922. Further, when the touch sensed on the hierarchical display area corresponds to a plurality of virtual layers corresponding to various hierarchies, the user interface apparatus may select a virtual layer corresponding to a top hierarchy from among the selected plurality of virtual layers of various hierarchies. The user interface apparatus may not display a virtual layer of a specific hierarchy, such as an upper hierarchy or a lower hierarchy, of the touched virtual layer on the hierarchical display area. Further, the user interface apparatus may readjust a size of the hierarchical display area.

In operation 1924, the user interface apparatus determines whether scroll input is sensed on the hierarchical display area.

When the scroll is sensed on the hierarchical display area in operation 1924, the user interface apparatus sequentially displays, on the flexible display unit, a virtual layer corresponding to the sensed scroll in a selection order in operation 1926. In an example, each virtual layer that was touched by the scroll may be included in the selection order, but is not limited thereto.

When the touch is not sensed on the hierarchical display area in operation 1920, or when the scroll is not sensed on the hierarchical display area in operation 1924, the method terminates.

Further, although exemplary embodiments of the present invention are described as displaying a plurality of virtual pages in response to detecting a bend above a reference threshold and selecting a target virtual page by detecting a touch on one of the virtual pages or by detecting another bend on the flexible display corresponding to the target virtual page, aspects of the invention are not limited thereto. For example, a terminal may directly navigate to a virtual page of an e-book, a webpage, an application, an operation of an application in response to a detection of a first bend. The terminal may navigate to a particular virtual page, webpage, application, or an operation according to the bend. Further, the terminal may navigate to various pages, applications, or operations in response to degree and/or direction of the bend.

Exemplary embodiments of the present invention may be applied in various ways to provide a variety of operation capabilities. For example, exemplary embodiments of the present invention may be applied to a web browser with multiple tabs or with multiple webpages that may be open. More specifically, a portion of a flexible display may be bent to display the multiple tabs or icons corresponding to various webpages. A touch may be detected on one of the tabs or icons to switch from a first tab of the web browser corresponding to a first webpage or current webpage to a second tab of the web browser corresponding to a second webpage. However, aspects of the invention are not limited thereto, such that the terminal may navigate from the first webpage to the second webpage in response to the bend. Further, the flexible display may switch from the first tab to a third tab or a fourth tab of the web browser according to a degree in bend of the flexible display or a touch corresponding to the respective tabs. The tabs of the web browser may be switched according to a direction of the bend.

Exemplary embodiments of the present invention may also be applied to an e-book including multiple pages and chapters. More specifically, a portion of a flexible display may be bent to display the multiple pages or chapters. A touch may be detected on one of the displayed pages or chapters to switch from a first page or chapter of the e-book to a second page or chapter of the e-book. However, aspects of the invention are not limited thereto, such that the terminal may navigate from the first page or chapter to a second page or chapter in response to the bend. Further, the terminal may navigate from the first page or chapter to a third page or chapter according to a degree in bend of the flexible display or a touch corresponding to the respective pages or chapters. The pages or chapters of the e-book may be switched according to a direction of the bend. Further, exemplary embodiments of the present invention may be used to switch from saved pages, sections, or chapters of the e-book.

Exemplary embodiments of the present invention may also be applied to switch from multiple applications that may be running or installed in a terminal with a flexible display. More specifically, a portion of a flexible display may be bent to display the multiple applications that may be running or installed in the terminal. A touch may be detected on one of the applications to switch from a first application or current application that is being run to a second application that is running or installed in the terminal. However, aspects of the invention are not limited thereto, such that the terminal may switch from a first application to a second application in response to the bend. Further, the flexible display may switch from the first application to a third application or a fourth application running or installed in the terminal according to a degree in bend of the flexible display or a touch corresponding to the respective application. The applications may be switched back and forth according to a direction of the bend.

Exemplary embodiments of the present invention may also be applied to switch from various operations, functions, or windows of an application that may be running or installed in a terminal with a flexible display. More specifically, a portion of a flexible display may be bent to display the multiple operations, functions, or windows of the application. A touch may be detected on one of the operations, functions, or windows to switch from a first operation, function, or windows to a second operation, function, or windows of the application. However, aspects of the invention are not limited thereto, such that the terminal may navigate from the first operation, function, or windows to the second operation, function, or windows in response to the bend. Further, the flexible display may switch from the first operation, function, or window to a third operation, function, or window or a fourth operation, function, or window of the application according to a degree in bend of the flexible display or a touch corresponding to the respective operations, functions, or windows. The operations, functions, or windows of the application may be switched back and forth according to a direction of the bend.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of exemplary embodiments of the present invention, or they may be of the kind well-known and available to those having skill in the computer software arts.

According to exemplary embodiments of the present invention, a user interface apparatus to sense a bend and a touch of a flexible display, to hierarchically output a plurality of virtual layers, and to display a virtual layer selected by a user may be provided. The user interface apparatus may display a three dimensional (3D) object to conform to a physical transformation of the flexible display, and may provide a user with an actual physical expression by adding a virtual layer selection and a screen switching operation, which may be executed using a touch and a scroll operation. Also, according to exemplary embodiments of the present invention, an intuitive interface based on a user's experience in the real world may be provided, such that the user may learn how to use an interface with little effort.

According to exemplary embodiments of the present invention, a user interface apparatus to hierarchically express a plurality of virtual layers by sensing a bend and a touch of a flexible display based on a curvature of a flexible display, to output a virtual layer based on the curvature, and output a virtual layer selected by a user. The user interface apparatus may display a 3D object to conform to a physical transformation of the flexible display, and may provide a user with an actual physical expression by adding a virtual layer selection operation and a screen switching operation, which may be executed using a touch and a scroll operation. Also, according to exemplary embodiments of the present invention, an intuitive interface based on the user's experience in the real world may be provided, such that the user may learn how to use an interface with little effort.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for controlling a terminal with a processor, comprising:
detecting a first bend on a flexible display unit;
determining, using the processor, whether the first bend comprises a curvature greater than or equal to a first curvature; and
displaying a plurality of virtual layers in a hierarchical order according to the first bend.

2. The method of claim 1, further comprising:
setting a hierarchical display area,
wherein the virtual layers are displayed in the hierarchical display area.

3. The method of claim 2, further comprising:
detecting a touch in the hierarchical display area,
wherein the hierarchical area ranges from a position of the touch to an edge portion of the flexible display unit.

4. The method of claim 2, wherein the hierarchical display area is set at a portion of the flexible display unit at which a reference bend has a curvature above a reference threshold.

5. The method of claim 1, further comprising:
detecting a touch on at least one of the virtual layers; and
displaying the virtual layer corresponding to the touch.

6. The method of claim 1, further comprising:
detecting a touch scroll on at least one of the virtual layers; and
sequentially displaying the virtual layers according to the touch scroll.

7. The method of claim 1, further comprising:
determining information about the first bend, the information about the first bend comprising at least one of a width, a direction, and the curvature of the first bend.

8. The method of claim 1, further comprising:
detecting a second bend on the flexible display unit;
determining whether the second bend comprises a curvature greater than or equal to a second curvature; and
displaying a virtual layer corresponding to the curvature of the second bend if the second bend is determined to be greater than or equal to the second curvature.

9. The method of claim 1, further comprising:
adjusting the curvature of the first bend to form a second bend.

10. The method of claim 8, wherein if the second bend is less than the second curvature and the first curvature, providing a screen that was displayed prior to detecting the first bend.

11. A terminal, comprising:
a flexible display unit to display an image provided on a virtual layer corresponding to a reference hierarchy;
a bending determination unit to determine whether a first bend of the flexible display unit comprises a curvature greater or equal to a first curvature; and
an interface unit to display a plurality of virtual layers in a hierarchical order according to the first bend.

12. The terminal of claim 11, wherein the interface unit sets a hierarchical area to display the virtual layers.

13. The terminal of claim 11, wherein the hierarchical display area is set at a portion of the flexible display unit at which a reference bend has a curvature above a reference threshold.

14. The terminal of claim 11, wherein the bending determination unit detects a touch on at least one of the virtual layers, and the interface unit displays a virtual layer corresponding to the detected touch.

15. The terminal of claim 11, wherein the bending determination unit detects a scroll, and the interface unit sequentially displays the virtual layer based on the scroll.

16. The terminal of claim 11, wherein the bending determination unit determines information about the first bend, the information comprising at least one of a width, a direction, and the curvature of the first bend.

17. The terminal of claim 11, wherein the bending determination unit detects a second bend and determines whether the second bend comprises a curvature greater than or equal to a second curvature, and
the interface unit displays a virtual layer corresponding to the second bend if the second bend is determined to be greater than or equal to the second curvature.

18. The terminal of claim 17, wherein the virtual layer corresponding to the second bend is a tab of a web browser corresponding to a webpage.

19. The terminal of claim 17, wherein the virtual layer corresponding to the second bend is a virtual page of an electronic book (e-book).

20. The terminal of claim 17, wherein the virtual layer corresponding to the second bend is an application running or installed in the terminal.

21. The terminal of claim 17, wherein the virtual layer corresponding to the second bend is a function of an application running or installed in the terminal.

22. The terminal of claim 17, wherein the curvature of the first bend is adjusted to form a second bend.

23. The terminal of claim 11, wherein the first bend is detected using piezoelectric film sensor.

24. A method for controlling a display of a terminal with a processor, comprising:
detecting a bend of a flexible display unit on which a plurality of virtual layers is displayed;
determining, using the processor, whether the bend comprises a curvature greater than or equal to a first curvature;
setting a hierarchical display area on the flexible display unit and displaying a plurality of indicators corresponding to the virtual layers in the hierarchical display area in response to the detected bend; and
displaying the virtual layer corresponding to the bend in the hierarchical display area of the flexible display unit.
